(19) United States
(12) Patent Application Publication
(10) Pub. No.: US 2025/0162554 A1
(43) Pub. Date: May 22, 2025

(54) Electronic Treadle Valve

(71) Applicant: Valcrum, LLC, Cypress, TX (US)

(72) Inventor: Alton L. Shelton, III, Cypress, TX (US)

(73) Assignee: Valcrum, LLC, Cypress, TX (US)

(21) Appl. No.: 18/511,728

(22) Filed: Nov. 16, 2023

(51) Int. Cl. B60T 11/34; B60T 8/36; B60T 8/50; B60T 13/66

(52) U.S. Cl. CPC B60T 11/34; B60T 8/3675; B60T 8/5037; B60T 13/662

(57) ABSTRACT

An electrically controlled valve for electrically controlling air brakes by releasing pressurized air at a controlled rate. The electrically controlled valve is useful for connecting a trailer with air brakes to a standard electrical connector on a towing vehicle that provides a proportional braking signal. The proportional signal is sent to the electrically actuated valve and a controller within the valve process the signal. When electrically actuated valve receives the proportional braking signal from the towing vehicle representing no braking force, electrically actuated valve to produce no air pressure to the air brake. When the electrically actuated valve receives the proportional braking signal from the towing vehicle representing full braking force, the electrically actuated valve provides air to the air brakes corresponding to full braking force of the air brakes.

### BACKGROUND OF THE INVENTION

Many vehicles are equipped to tow trailers with electronically controlled brakes. Frequently, towing vehicles include integrated towing packages that have standard connectors such as flat four and seven pin connectors. As such many vehicles come from the manufacturer with an electronic brake control or are set up to receive an easily installed aftermarket electronic brake controller. When a brake controller is installed as original equipment in a towing vehicle, or an aftermarket controller is installed, the towing vehicle will have an output of an electronic signal that is proportional to the braking force exerted by the towing vehicle's brakes. The proportional braking signal from the towing vehicle is useful to act as in input to a trailer attached to the towing vehicle. The proportional signal from the towing vehicle is a commonly used feature of the seven pin connector on a towing vehicle.

Medium and heavy duty trailers can have air brakes. Therefore, a proportional braking signal is not useful for controlling a typical trailer with air brakes. The input for a typical trailer with air brakes is air pressure from the towing vehicle. Using air as a signal to actuate the trailer brakes has been a traditional way to actuate trailer brakes. However, using an air line to signal how much braking force should be applied at the trailer wheels was problematic. Traditionally, in a semi tractor or other heavy vehicle, a brake pedal actuated a treadle valve. The treadle valve sent air through line (a signaling circuit) to actuate a relay, then the relay actuated the brakes through a separate circuit from the signaling circuit. Such a system includes inherent delay. That delay arises for the fact that air is very compressible and therefore, air in the signaling circuit may take some time to reach a necessary signaling pressure. Likewise, when brakes are released through a treadle valve and signaling circuit the pressurized air in the signaling circuit may not decompress as rapidly as a user would desire to release the brakes. A strategy to minimize the delay in the pneumatic signaling line has been to make it relatively small to minimize the delay caused by the compressibility of air. While such a strategy is useful, there will still be delay in such a configuration.

Another drawback to a traditional treadle valve as a signaling mechanism is that most towing vehicles that are not semi tractors, have no treadle valve or pneumatic lines. An improved system for a proportional electrical braking signals from a towing vehicle to control trailers with pneumatic brakes would be useful to virtually eliminate delay in a traditional signaling line actuated by a pneumatic treadle valve. Such an electrically controlled valve will also enable vehicles lacking the complex pneumatic components to tow trailers with air brakes.

### SUMMARY OF THE INVENTION

The present invention is an electronically controlled brake valve having a housing with an inlet port. The inlet port is for receiving pressurized fluid from a pressurized fluid source. The housing has an inlet chamber that is in fluid communication with the inlet port. The inlet chamber has an inlet seat. An inlet valve is held within the inlet chamber and the inlet chamber surrounds the inlet valve. The inlet valve has a bore through it and an inlet valve seat that circumscribes the bore. The inlet valve is movable in an axial direction between a closed position wherein the inlet valve seat contacts the inlet seat and is movable to an open position wherein the inlet valve seat is spaced from the inlet seat. A spring biases the inlet valve toward the closed position. A control piston is slidably retained in a modulation chamber. The control piston is sealing mated with a sidewall of the modulation chamber to divide the modulation chamber into a dispensing side and a control side. The control piston has a control piston seat that is for contacting the inlet valve seat. The control piston is moveable between multiple positions. The control piston has an open position wherein the control piston seat is spaced from the inlet valve seat. The control piston has a holding position wherein the control piston seat contacts the inlet valve seat while the inlet valve seat is in contact with the inlet seat. The control piston has a cracked position in which the control piston seat contacts the inlet valve seat and the inlet valve seat is spaced from the inlet seat thereby locating the inlet valve into its open position. The open position of the inlet valve provides fluid communication between the inlet chamber and the dispensing side. The closed position of the inlet valve seals the inlet chamber from fluid communication with the dispensing side. An outlet port is located within the housing. The outlet port is in fluid communication with the dispensing side. A modulation valve selectively connects a modulation passage to the control side to facilitate the flow of fluid into the control side and for selectively releasing pressurized fluid from the control side. The electronically controlled valve has a controller for receiving a proportional braking signal and the controller is for processing the proportional braking signal and operating the modulation valve to control the fluid pressure on the control side of the valve thereby moving the control piston to control fluid flow at the outlet port.

### BRIEF DESCRIPTION OF THE DRAWINGS

FIG. 1 is a side view of a trailer using the system of the present invention connected to a towing vehicle;

FIG. 2 is a top view of the trailer and towing vehicle of the present invention shown in FIG. 1 that also includes a rear view of the towing vehicle that shows both ends of an electrical connector adjacent to each other;

FIG. 3 is a top view of the trailer shown in FIGS. 1 and 2;

FIG. 3A is magnified view of area 3A shown in FIG. 3;

FIG. 4 is a schematic breakout view of the components of the system that is primarily for illustration of the pneumatic connections;

FIG. 5 is a schematic breakout view of the components of the system that is primarily for illustration of the electrical connections of the components;

FIG. 6 is a side view of the electronically controlled valve showing the inlet port;

FIG. 7 is a side view of the electronically controlled valve shown in FIG. 6 showing the outlet port;

FIG. 8 is a sectional view of the electronically controlled valve taken about line 8- 8 in FIG. 6;

FIG. 9 is a sectional view of the electronically controlled valve taken about line 9-9 in FIG. 7;

FIG. 10 is a side view of the housing for the electronically controlled valve shown in FIGS. 6-9 showing the inlet port;

FIG. 11 is a side view of the housing shown in FIG. 10 showing the outlet port

FIG. 12 is a sectional view taken about line 12-12 in FIG. 11 showing the open position of the control piston and the outlet port;

FIG. 13 is a sectional view like that in FIG. 12 showing the cracked position of the control piston and the outlet port;

FIG. 14 is a sectional view like that shown in FIGS. 12 and 13 showing the holding position of the control piston and the outlet port;

FIG. 15 is a sectional view taken about line 15-15 in FIG. 10 showing the open position of the control piston and the inlet port;

FIG. 16 is a sectional view like that in FIG. 15 showing the cracked position of the control piston and the inlet port; and

FIG. 17 is a sectional view like that shown in FIGS. 15 and 16 showing the holding position of the control piston and the inlet port.

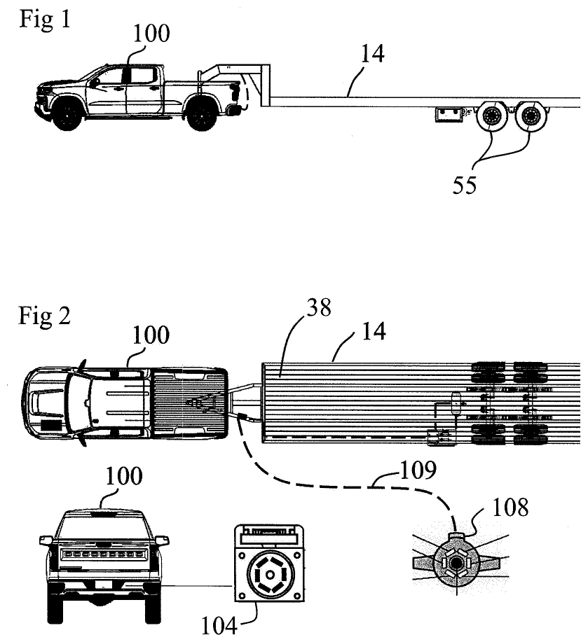

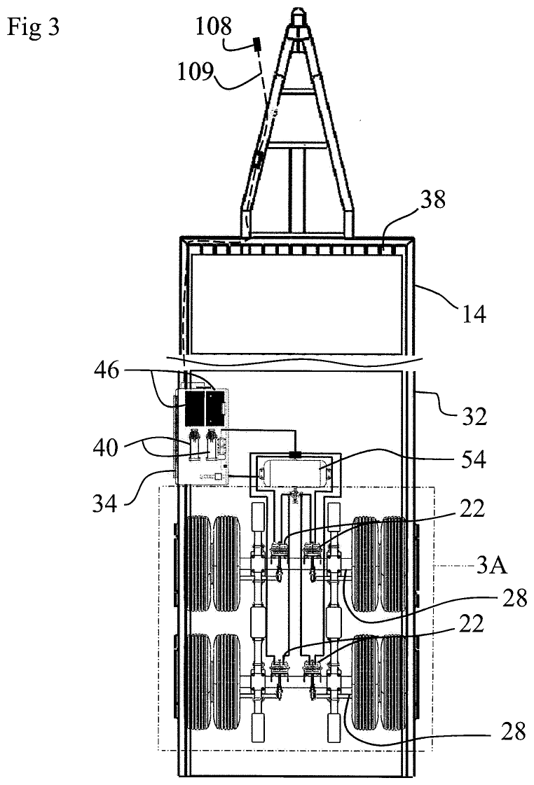

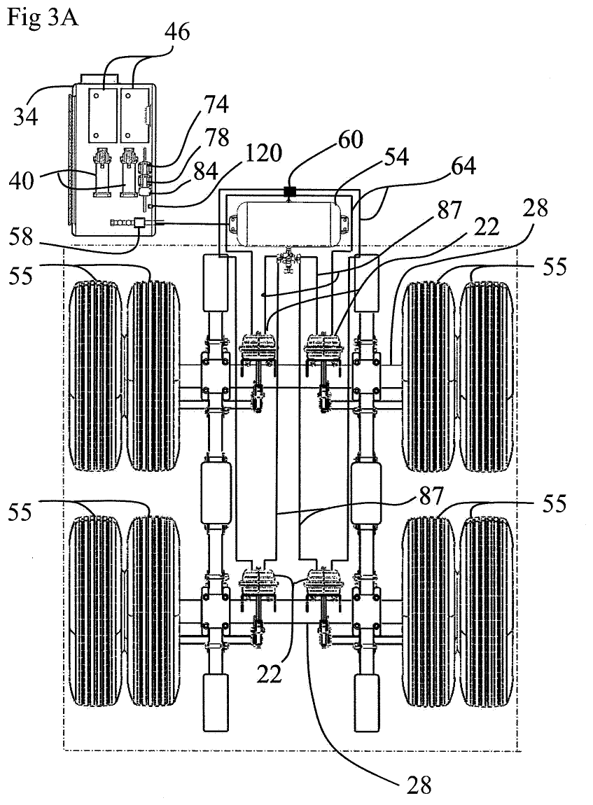

### DETAILED DESCRIPTION OF INVENTION

The present invention is related to a system 8 for controlling air brakes on a trailer using a towing vehicle that has commonly available electrical connections for use with a trailer having electrically controlled brakes that are typically hydraulic brakes or electric brakes. Air brakes are used for their reliability and safety and are typically used in conjunction with a towing vehicle that supplies compressed air through hoses that connect to a trailer that has air brakes. Typical pickup trucks that are used as towing vehicles 100 do not have an air supply that may be connected to a trailer 14 that uses air brakes 22. The air brakes 22 are mounted on the axles 28 of the trailer, as is well known in the art. The internal components of the air brakes 22 are not shown because such components are well known in the art of air brakes. The components of the air brakes will be discussed as necessary to describe how the present invention works with the air brakes 22.

In the case of the trailer 14 shown, the trailer has a frame 32 that includes a toolbox 34 below the deck 38. The deck 38 may be a wooden board deck or other type of material. The trailer 14 is a gooseneck type trailer, as is common for medium to heavy duty trailers. The air brakes 22 may include a service brake chamber that has a diaphragm located within the service brake chamber. The diaphragm in the service brake chamber is connected to a service brake pushrod. When pressurized air is introduced into the service brake chamber, the service brake pushrod extends to an extended position. The service brake chamber also includes a return spring that retracts the service brake pushrod when air is removed from the service brake chamber. The brake also includes a spring brake chamber and a spring brake diaphragm that opposes a spring brake diaphragm within the spring brake chamber. The spring brake chamber includes a spring brake pushrod that is adjacent to the spring brake diaphragm. When pressurized air is introduced into the spring brake chamber, the spring brake pushrod is retracted to a retracted position when the spring brake diaphragm compresses the spring brake spring. When air is removed from the spring brake chamber, the spring brake spring moves the spring brake pushrod to an extended position. Movement of the spring brake pushrod to the extended position causes movement of the service brake pushrod to its extended position. Typically, the service brake pushrod is connected though a yoke and clevis connection to a slack adjuster when drum brakes are used as foundation brakes. A slack adjuster and yoke connection may not be used when disc brakes are used as foundation brakes at the wheels. As is common with drum foundation brakes, a spring brake is used for safety with air disc brakes so that in the absence of pressurized air, the brake spring will actuate the disc brake. In a disc brake, a service brake chamber actuates a piston to actuate the brake 22.

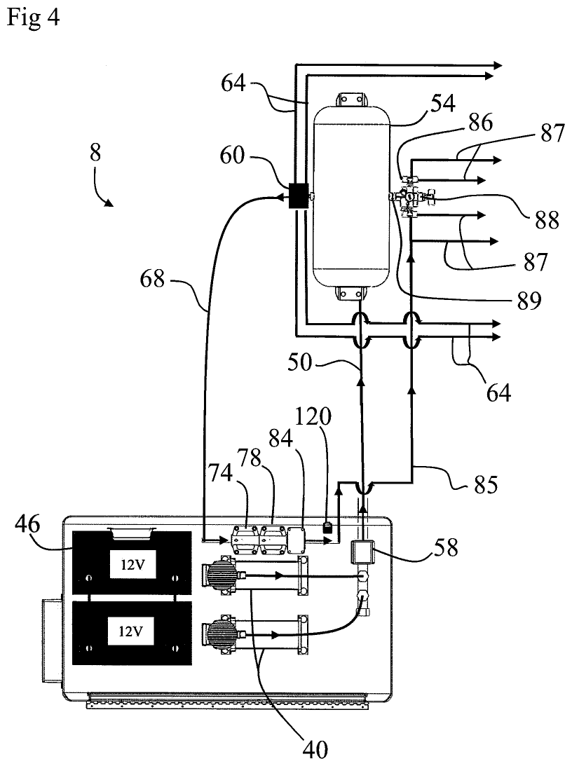

The trailer 14 has a set of compact air compressors 40 that fit within the toolbox 34 below the deck 38. It is contemplated that a single compressor 40 may be used as long as it is appropriately sized. The location of the components within the toolbox 34 is a convenient location on the trailer 14, however, other locations and/or storage containers may work just as well. FIG. 4 shows how the compressors 40 interact with other components of the system. The compressors 40 receive power from batteries 46. As the compressors 40 run, they supply air through line 50 that is connected to supply tank 54. A pressure switch 58 governs the pressure in the supply tank 54. The pressure switch 58 switches the compressors 40 on when the pressure in the supply tank 54 drops below 90 PSI and shuts off the compressors 40 when the pressure in the supply tank 54 reaches 150 PSI. As the air pressure in the supply tank 54 rises, pressurized air flows through the manifold 60 to the spring brakes via lines 64. The flow of air though lines 64 into the spring brakes releases them from their locked state so the wheels 55 may rotate. Manifold 60 also directs pressurized air through line 68. Line 68 is connected to a main air filter 74 and a micro air filter 78. The filters 74, 78 lead into an electrically actuated valve 84 that is designed to release air from the supply tank 54 at a controlled rate. The pressurized air released from the electrically actuated valve 84 is directed to the brakes 22 on the trailer 14.

The pressurized air released from the electrically actuated valve 84 is directed through line 85 and into the valve 86. One side of the valve 86 acts as a manifold 88 to distribute pressurized air to individual brake lines 87 that are each connected to a brake 22. In this case, the trailer 14 is a tandem axle trailer and the pressurized air is distributed through four brake lines 87 to each brake 22. Another side of the valve 86 is a pressure release valve 89 that is in fluid communication with the supply tank 54. Opening of the pressure release valve 89 releases all of the pressurized air in supply tank 54. The pressure release valve 89 is a normally open valve and can receive electrical current that energizes the valve and holds it closed. In a non- energized state corresponding to the absence of electrical current, the release valve 89 is open and releases all of the pressure in supply tank 54.

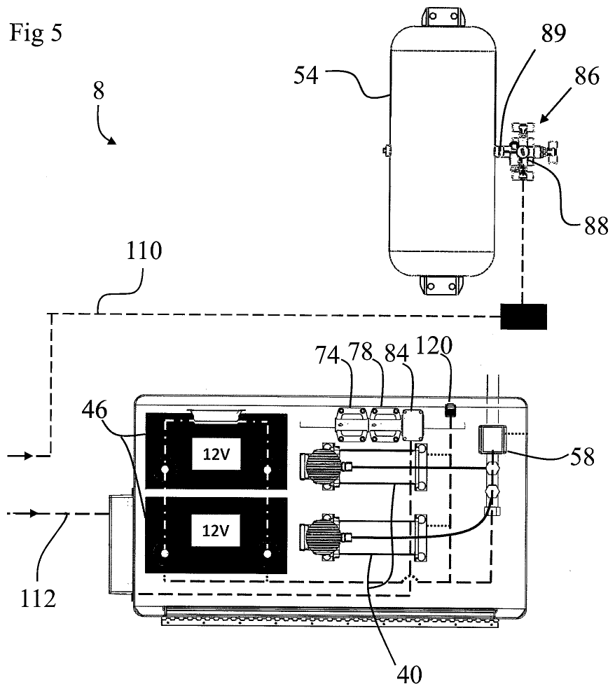

The controlled release of pressurized air from the electrically actuated valve 84 is directed from a controller 90 within the electrically actuated valve 84. The controller 90 takes a proportional braking signal that the electronically actuated valve 84 receives and is commonly available on a standard seven pin connector integrated with the towing vehicle 100. FIG. 2 shows a view of the truck end 104 of the seven pin connector and the trailer end 108 of the seven pin connector is also shown. In addition to the proportional braking signal that is available to the trailer 14 when the trailer end 108 of the seven pin connector is connected to the towing vehicle 100, there is also a power connection. The power connection on the seven pin connector from the towing vehicle 100 may be constant power, or may be switched power so that no power is available when the ignition key is in the off position depending on how the towing vehicle 100 is configured. A wiring harness 109 extending from the trailer end 108 of the seven pin connector includes a constant power wire 110 and a wire 112 for the proportional braking signal. FIG. 5 shows how the wires 110, 112 are connected to the components. The proportional braking signal is fed into the electronically actuated valve 84. The proportional braking signal from the towing vehicle 100 is movable between a signal representing no braking force from the towing vehicle 100 and a signal representing full braking force from the towing vehicle 100. When the electronically actuated valve 84 receives the proportional braking signal from the towing vehicle 100 representing no braking force, no air is supplied to the brakes 22 on the trailer 14. Likewise, when the electronically actuated valve 84 receives the proportional braking signal from the towing vehicle 100 representing full braking force, air is supplied to the brakes 22 on the trailer corresponding to full braking force on trailer 14. In this manner, the electronically actuated valve 84 actuates the brakes in a proportional manner to the signal it receives from the towing vehicle 100.

The system of the present invention may also provide information and configurability through a wireless connection. That wireless connection may be from the system 8 to a device in the towing vehicle 100 that could display information on a panel in the towing vehicle, or that wireless connection may be to a Bluetooth device such as a phone. Information that may be displayed wirelessly can include, the pressure in the supply tank 54, voltage in the batteries 46 on the trailer 14, and pressure being supplied to the brakes 22 on the trailer 14 through lines 64. Wireless configuration may be made to the system 8 such as changing the amount of braking force applied to the trailer brakes 22 in response to changing loads on the trailer 14. Another configuration that may be made from the Bluetooth device is purposely applying the trailer brakes. At certain times a user may want to purposefully lock the brakes 22 and one of those times may be loading heavy equipment onto the trailer. At times when heavy excavating equipment or other implements are loaded on the trailer, the weight of the equipment being placed on the trailer can lift weight from the wheels of the towing vehicle and cause the towing vehicle 100 to lurch forward. The ability to lock the wheels 55 of the trailer at appropriate times is a useful safety feature. Additionally, a user may wish to intentionally lock the service brakes during a department of transportation inspection to prove the brakes 22 work.

When a user of the trailer 14 has connected it to the towing vehicle 100 he will connect the trailer end 108 of the seven pin connector to the towing vehicle 100. Once the trailer end 108 of the seven pin connector is connected to the towing vehicle 100 and it delivers power through the constant power wire 110, relay 120 will be activated that will switch on the compressors 40 until the maximum PSI is reached in the supply tank 54. The constant power wire 110 also delivers power to release valve 89, thereby closing the release valve 89. As the compressors 40 pressurize the supply tank 54, air will be directed through the manifold 60 and thereby release the spring brakes. This will also make air available to the electrically actuated valve 84. Although pressurized air is available to the electrically actuated valve 84 at that time, the service brakes will not be activated until the electronically actuated valve 84 receives a proportional braking signal so the electrically actuated valve 84 can release pressurized air from supply tank 54 in a controlled manner. That proportional braking signal may be a square wave, DC voltage, or other waveform. In the event that the trailer end 108 of the seven pin connector is disconnected from the towing vehicle 100, that will disconnect the constant power wire 110 from current that the towing vehicle 100 supplies. As such, when the trailer end 108 is disconnected, pressure will be released from the supply tank 54 and this will cause the spring brakes to activate and lock the wheels 55 on the trailer 14. In this manner, the trailer end 108 of the seven pin connector can replace traditional lanyards that were required with traditional electrical brakes. The lanyards on traditional electric brakes are typically connected to a non- conductive strip held between a normally closed safety switch that activates the electronic brakes when the lanyard is pulled in the event of a trailer separation. These switches on trailers with traditional electric brakes have been proven to be notoriously unreliable. The traditional safety switches often stick open and provide no utility when the lanyard is pulled because the switch will not actuate the brakes in the stuck open position. In addition to being unreliable, the traditional safety switches require an operator to consciously remember an additional step of attaching the lanyard. The attachment of the trailer end 108 of the seven pin connector of the present system 8 cannot be overlooked because the spring brakes on the trailer 14 will remain locked until the trailer end 108 is connected to the towing vehicle. In other words, it is impossible for the user to forget to plug in the trailer end 108 of the seven pin connector. In the event of a trailer 14 disconnected using the present system 8, the trailer brakes 22 will lock automatically when the supply tank 54 is discharged as the release valve 89 opens in the absence of electrical current and the spring brakes activate. This enables the trailer 14 to be safely loaded and unloaded when the trailer end 108 is disconnected and is particularly useful when trailers 14 are left at a location without the towing vehicle 100.

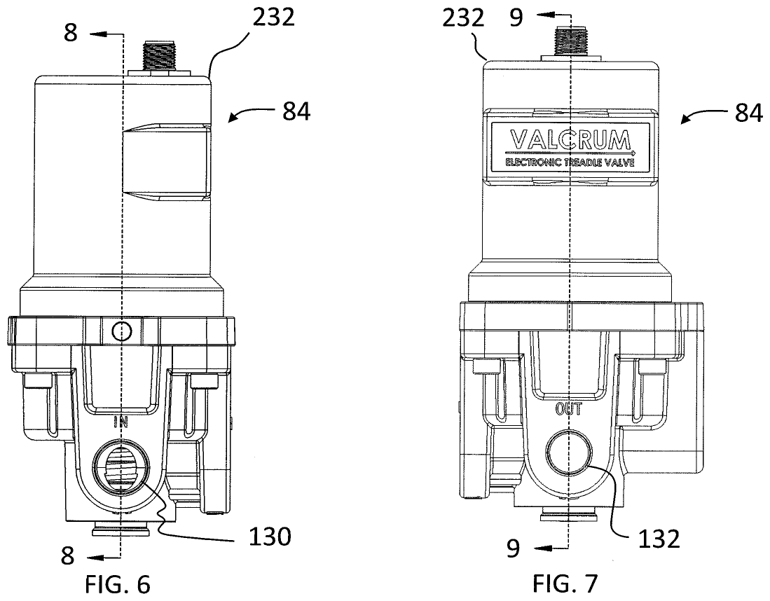

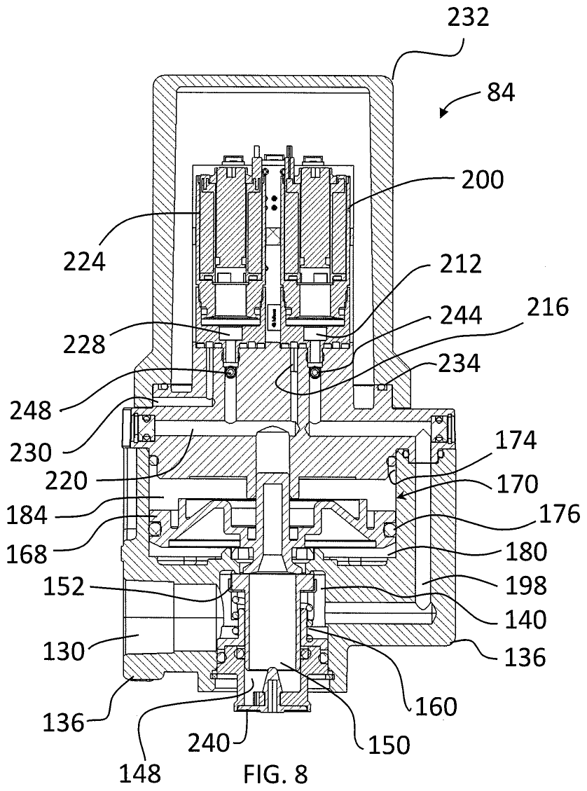

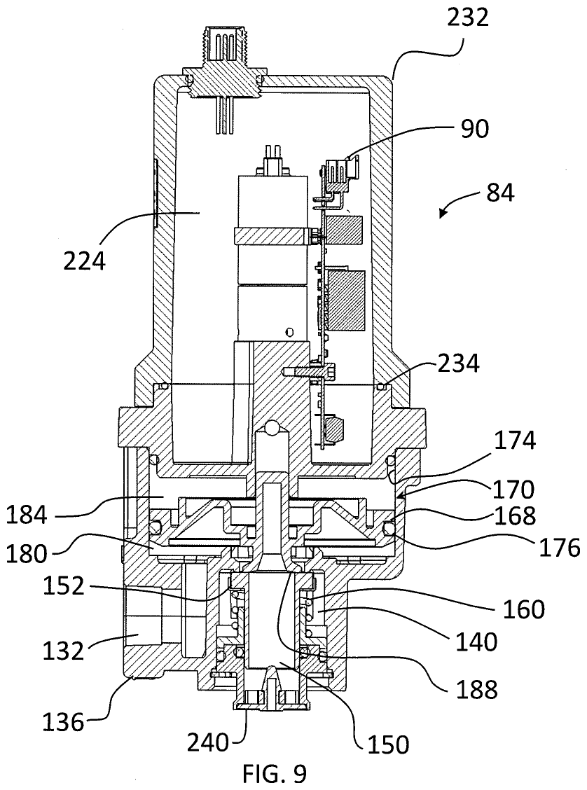

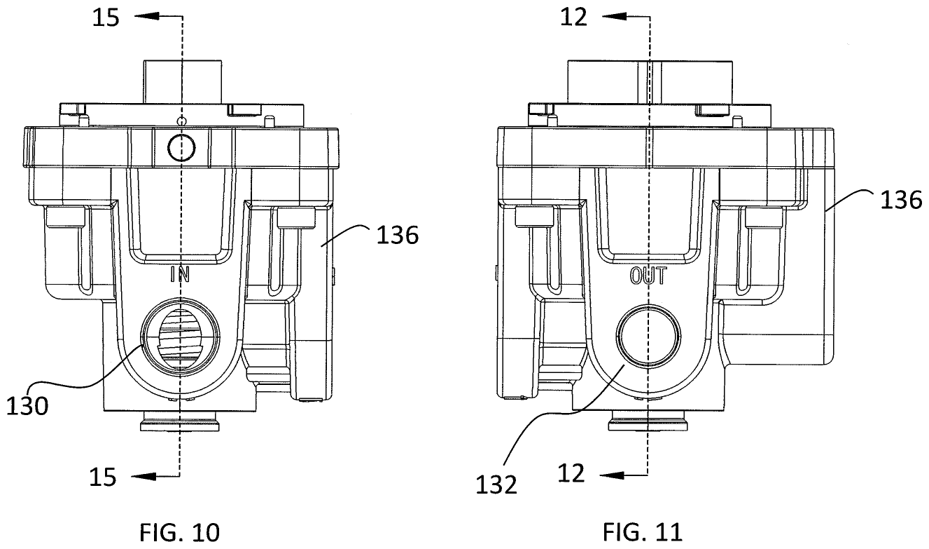

The electronically actuated valve 84 of the system is shown in further detail in FIGS. 6-17. FIG. 6 shows an inlet port 130 and FIG. 7. shows an outlet port 132. Both the inlet port 130 and outlet port 132 are in a housing 136 that directs the flow of air through the electronically actuated valve 84. Air enters the inlet port 130 from a pressurized air source such as air supply tank 54, the air then travels directly to an inlet chamber 140. The inlet chamber 140 within the housing 136 is an annular chamber that has an inlet seat 144 which is a flat annular area. The inlet chamber 140 is generally a cylindrically shaped chamber within the housing 136 that is directly connected to the inlet port 130. The inlet chamber 140 holds an inlet valve 148 that is a cylinder having a bore 150 through the center. On the upper end of the inlet valve 148 is a flange 152 having an inlet valve seat 154 that circumscribes the bore 150. The inlet valve seat 154 is designed to mate with the inlet seat 144 that is part of the housing 136 within the inlet chamber 140. The inlet seat 144 mates with the inlet valve seat 154 in an airtight manner. The inlet valve 148 has a bore 150 that extends completely through it and accommodates the flow of air therethrough. The inlet valve 148 is movable in an axial direction between a closed position in which the inlet valve seat 154 contacts the inlet seat 144, and an open position, in which the inlet valve seat 154 is spaced from the inlet seat 144. A spring 160 is wrapped around the outside of the inlet valve 148 and pushes against the inlet valve 148 biasing the inlet valve 148 into the closed position as shown in FIG. 8.

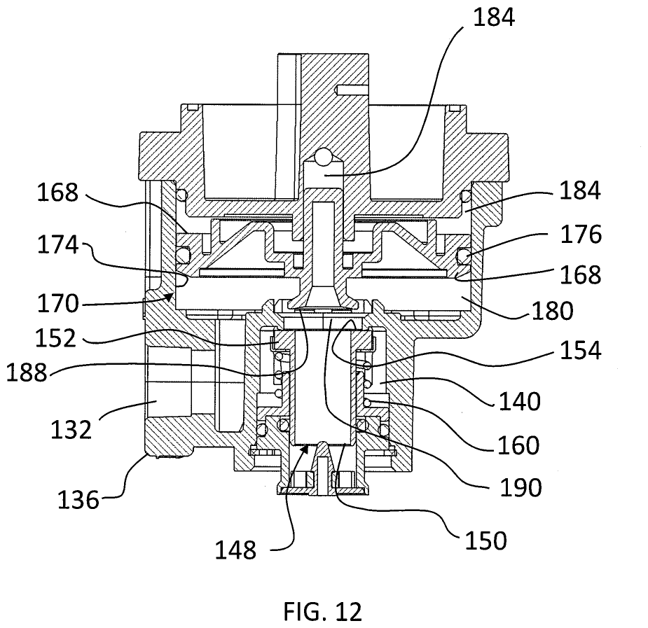

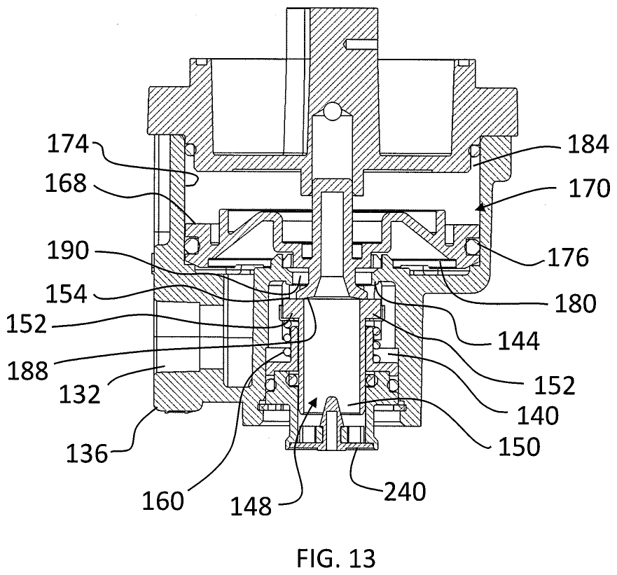

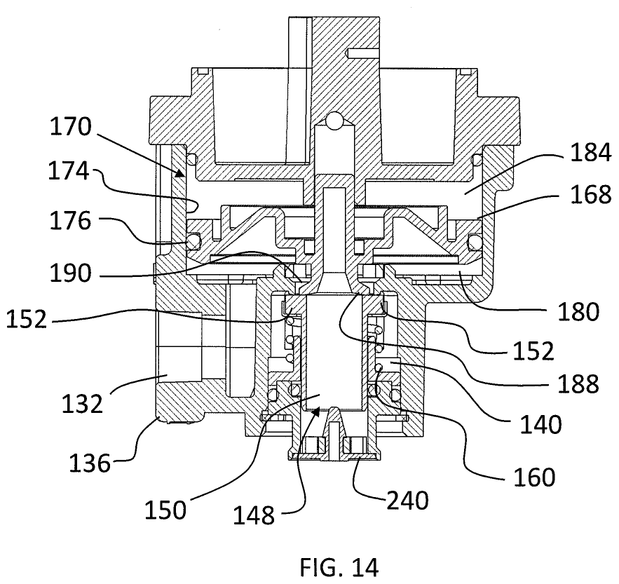

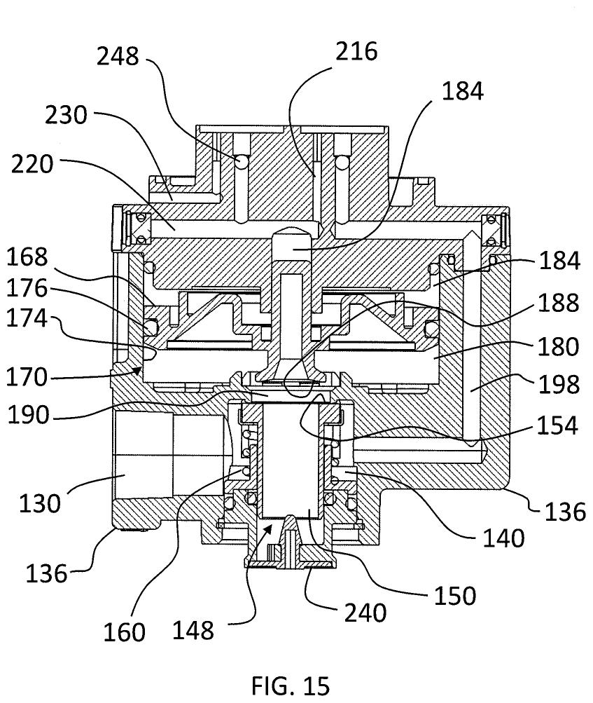

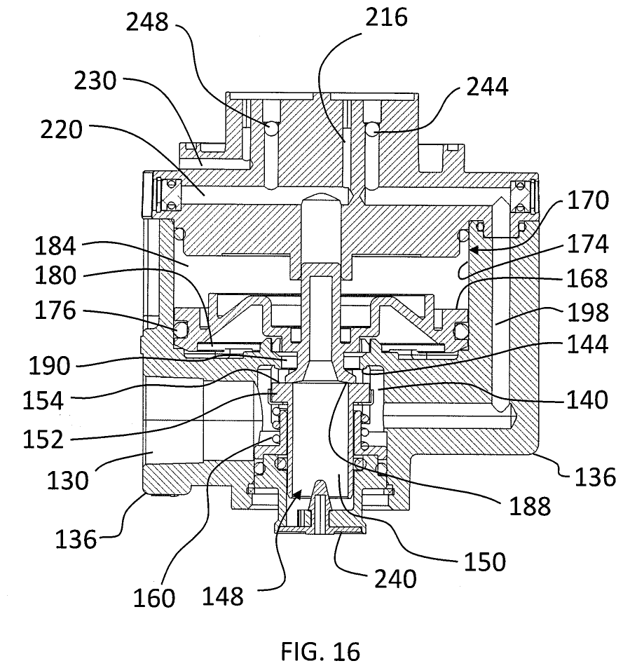

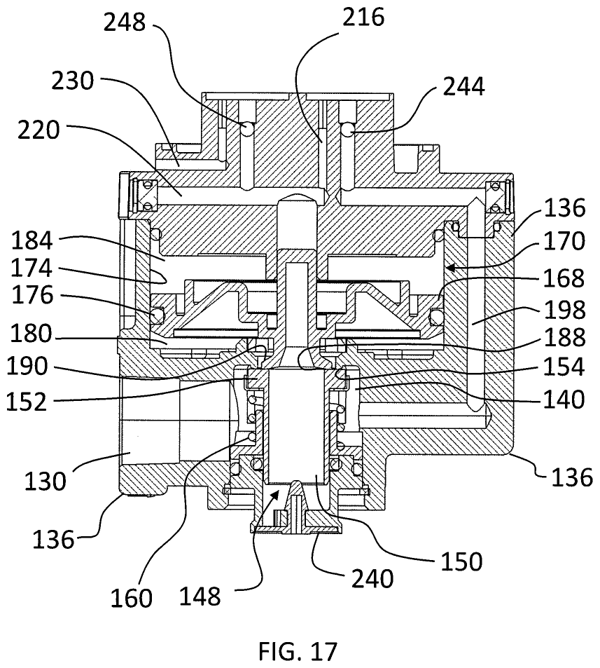

A control piston 168 is slidably retained in a modulation chamber 170 and sealed against a sidewall 174 of the modulation chamber 170 with an O-ring 176. The control piston 168 divides the modulation chamber 170 into a dispensing side 180 and a control side 184. The control piston 168 has a control piston seat 188 for contacting the inlet valve seat 154. The control piston 168 is movable between several positions within the modulation chamber 170. A first position of the control piston 168 is the open position in which the control piston seat 188 is spaced from the inlet valve seat 154. This is shown in FIGS. 12 and 15. When the control piston 168 is in the open position, the inlet valve 148 is in its closed position and blocks the opening 190 between the inlet chamber 140 and the dispensing side 180 of the modulation chamber 170. A second position of the control piston 168 is the holding position. The holding position is shown in FIGS. 14 and 17. When the control piston 168 is in the holding position, the inlet valve 148 is in its closed position and blocks the opening 190 between the inlet chamber 140 and the dispensing side 180 of the modulation chamber 170. Additionally, the control piston 168 blocks the bore 150 extending through the inlet valve 154 because of the airtight seal of the control piston seat 188 against the inlet valve seat 154. A third position of the control piston 168 is the cracked position. The cracked position of the control piston 168 is shown in FIGS. 13 and 16. When the control piston 168 is in the cracked position, the control piston seat 188 contacts the inlet valve seat 154, and the inlet valve seat 154 is spaced from the inlet seat 144. The cracked position of the control piston 168 locates the inlet valve 140 in its open position because the control piston 168 has displaced the inlet valve 140 against the bias of spring 160. The cracked position of the control piston 168 will allow air to pass into the dispensing side 180 of the modulation chamber 170 via the inlet port 130 through the opening 190, but not allow air to pass through the bore 150 of the inlet valve 140. The cracked position of the control piston 168 also allows air from the dispensing side 180 to flow into the outlet port 132. The cracked position of the control piston 168 provides a path for air to flow from pressurized air entering the inlet port 130 flowing through the dispensing side 180 then through the outlet port 132.

The valve 84 includes a modulation passage 198 that is in fluid communication with the inlet chamber 140. The modulation passage 198 is contained within the housing 136. The modulation passage 198 is connected to a first valve 200. The first valve 200 is an electronically actuated solenoid type valve that is operated by a controller 90 that receives the proportional braking signal. The first valve 200 moves a plunger 212 that selectively connects the modulation passage 198 to the control side 184. Pressurized air flows past the first valve 200 when the plunger 212 is moved from a sealed position and enters the control side through passage 216. Pressurized air may be dissipated from the control side 184 via a bleed passage 220. A second valve 224 has a plunger 228 that may be selectively moved from a sealed position, and the second valve 224 is also connected to the controller 90. The second valve 224 selectively connects the bleed passage 220 to passage 230 that leads to ambient atmosphere. The valves 200, 224 and controller 90 are protected by a cover 232 sealed by an O-ring 234 on top of the housing 136. Passage 220 to ambient atmosphere is below the O-ring 234. Although the FIGS. show a first and second valve 200, 224, it is contemplated a single valve may modulate the flow of pressurized air in and out of the control side 184. This may be accomplished by a solenoid actuating a spool valve, thereby modulating the air pressure in the control side 184. It is also contemplated that a separate passage outside of the housing 136, other than the modulation passage 198, may be used to supply pressurized air through valves 200, 224. In such a configuration, there would be no modulation passage 198 in the housing 136. It is preferable to have a modulation passage 198 within the housing 136 itself because this allows for a single inlet port 130. In the configuration shown, the electronically actuated valve 84 needs only a single source for pressurized air. All of the air for the electronically actuated valve 84 enters through the inlet port 130 which ultimately is used to supply air to brakes via the outlet port 132, as well as supply the air used to modulate the pressure and flow to the air brakes 22 via the outlet port as will be described below.

The electronically actuated valve 84 serves as a self-contained modulation source for providing pressurized air to air brakes 22. Although the FIGS. show a system used in conjunction with a trailer 14, the electronically actuated valve 84 could be used to modulate air pressure to brakes in a self-propelled vehicle that is used for towing trailers. In such a case, the electronically actuated valve 84 would replace a traditional master cylinder or air based system in a towing vehicle. Operation of the electronically actuated valve 84 is initiated by the proportional braking signal that is sent to the electronically actuated valve 84 and received by the electronically actuated valve 84. The proportional braking signal is then fed into the controller 90. Based on the proportional braking signal, the controller 90 will actuate the valves 200, 224 within the electronically actuated valve 84 to provide and modulate necessary supply of pressurized air to brakes 22 via the outlet port 132 so the brakes may be selectively applied and released. In the case of a proportional braking signal representing no braking force, the valves 200, 224 will work to release air from the control side 184 of the control piston 168. This is shown in FIGS. 12 and 15. In such a case, the control piston seat 188 is lifted and spaced from the inlet valve seat 154. This is shown in an exaggerated manner because the space the control piston seat 188 and the inlet valve seat 154 may be small, but in a case where there is significant pressure in the air brakes 22 and the proportional braking signal drops to no braking force quickly, the pressure in the air brakes 22 will be significant and the valves 200, 224 will work in conjunction to bleed air from the control side 184 as fast as possible. A high differential in pressure in which there is a relatively high air pressure in the air brakes 22 and in the outlet port 132 will mean there is a relatively high pressure in the dispensing side 180 compared to the control side 184. This pressure differential will cause the control piston 168 to move away from the inlet valve 148, thus moving the control piston seat 188 away from the inlet valve seat 154. This will expose the bore 150 in the inlet valve 148, which acts as an exhaust port from the electronically actuated valve 84. This is the case because the outlet port 132 will be in fluid communication with the dispensing side 180, which is in communication with opening 190 that leads to the inlet valve 148, which has its bore 150 leading to ambient air. When the pressure in the outlet port 132 is higher than ambient air, a flow of air from the outlet port 132 through the dispensing side 180 and out of the bore 150 will be established. A check valve 240 on the bottom of the bore 150 ensures that air will only be able to flow out of the electronically actuated valve 84 and not be drawn into the electronically actuated valve 84. This will prevent contaminants from entering the braking system and only allow filtered air that is received via the inlet port 130 to be circulated through the braking system and the electronically actuated valve 84. The valves 220, 224 work in conjunction via operation from the controller 90 to facilitate this open position of the control piston 168 by having the first valve 200 be moved to its closed position and the second valve 224 be moved to its open position. When the first valve 200 is in its closed position, it will block the modulation passage 198 from supplying air to the control side 184 and the second valve 224 will leave the control side 184 open to ambient air when it is open. As such, the pressure above the control piston 168 on the control side 184 will be relieved, which will allow the control piston 168 to move to its open position.

In the case of a proportional braking signal that indicates a driver wants to hold the amount of braking force where it is, the controller 90 will actuate the first and second valves 200, 224 in a manner that will locate the control piston 168 in its holding position. The holding position is shown in FIGS. 14 and 17. The holding position requires the controller 90 to balance pressures and forces within the housing 136. The holding position means the electronically actuated valve 84 is maintaining a certain level of pressure in the outlet port 132 and therefore that same pressure in the brakes 22. The holding position of the control piston 168 corresponds to it having its control piston seat 188 in sealing contact with the inlet valve seat 154. The holding position of the control piston 168 also corresponds to the inlet valve seat 154 preventing flow through opening 190. These aforementioned relationships in the holding position mean that the inlet valve 148 seals the dispensing side 180 from both the bore 150 of the inlet valve 148 and the outlet port 132. As such, no pressurized air from the outlet port 132 is exhausted via the bore 150, nor will any additional pressurized air be allowed to flow from the inlet port 130 into the outlet port 132. As mentioned above, spring 160 biases the inlet valve 148 into its closed position. Spring 160 has a predetermined amount of force that is exerted upon the inlet valve 148 to seal it against the inlet seat 144. Any force above that predetermined force will cause the inlet valve 148 to move toward its open position. The first and second valves 200, 224 control the pressure in the control side 184 of the modulation chamber 170 through the controller 90 operating them. The controller 90 is connected to a first pressure transducer 244 and a second pressure transducer 248 that provide information to the controller 90 to enable it to determine how to actuate the first and second valves 200, 224. The first pressure transducer 244 measures the pressure in the modulation passage 198, which also corresponds to the pressure in the inlet port 130 and inlet chamber 140. The second pressure transducer 248 measures pressure in the bleed passage 220 which also corresponds to the pressure in the control side 184. When the controller 90 receives a proportional braking signal that represents a desire to hold the brakes at a particular level of force, the controller 90 must maintain a particular pressure on the control side 184. As a first part of its evaluation on how to actuate the valves 200, 224, the controller 90 must determine whether there is enough pressure in the control side 184 to cause the control piston 168 to move with enough force to move the inlet valve 148 to its open position. This pressure is dependent upon the area of the control piston 168 (corresponding to the area dictated by the diameter of the modulation chamber) multiplied by the pressure over that area of the control piston 168. That predetermined pressure necessary for the control piston to move the inlet valve 148 against the bias of spring 160 is the crack pressure. If the controller 90 reads a lower pressure in the control side 184 it is known that the inlet valve 148 must not have been moved to its open position or there is less than the crack pressure of air in the outlet and air brakes 22. Such a condition would be a non-applied condition for the air brakes and not corresponding to a hold position that is used to maintain enough air in the air brakes 22 to keep them applied with a constant force. As the pressure in the control side 184 is increased above the crack pressure, it will move the inlet valve 154 into its open position until enough pressurized air enters the dispensing side 180 to equalize the pressure on the control side 184. As pressure on the control 184 is increased a correspondingly equal increased pressure will be required to push the control piston into equilibrium and each incremental increase on the dispensing side 180 will increase the amount of pressure in the outlet port 132 and air brakes 22. Equal pressure on both the control side 184 and the dispensing side 180 is the pressure condition that corresponds to the holding position. As the first and second valves 200, 222 selectively change pressure, they selectively change the pressure in the outlet port 133 and air brakes 22. Thus, when the controller 90 operates the valves 200, 224 to maintain pressure on the control 184, the valves 200, 224 maintain braking force at a desired level communicated to the controller through the proportional braking signal.

The open position of the control piston 168 is a temporary intermittent condition that corresponds to a pressure imbalance between the control side 184 and the dispensing side 180 of the modulation chamber 170. The controller 90 can increase pressure in the control side 184 when a proportional braking signal indicates a driver desires more braking force. When the controller 90 increases the pressure in the control side 184 of the by opening the first valve 200 and not bleeding the pressure in the control side 184 by opening the second valve 224, the pressure in the control side 184 will rise as pressurized air flows from the inlet port 130, through the inlet chamber 140 through the modulation passage and through the first valve 200 into the control side 184. Immediately thereafter, the control piston 168 will be driven toward the inlet chamber 140 by the pressure imbalance until the pressure rises in the dispensing side 180 via the opening 190 being unblocked by the inlet valve 148 being in its open position. Once the pressure stabilizes on both sides of the control piston 168, the holding position will be maintained and so will the braking force. The actuation of the valves 200, 224 is nearly instantaneous because their responsiveness is largely determined by how quickly electricity may be provided to the valves 200, 224. Unlike traditional valves, changing pressure on the control side 184 of the control piston 168 is not accomplished by a lengthy passage from a location remote to the electronically actuated valve 84. The pressurized air acting on the control side 184 is derived from the same single inlet port 130 that also supplies the air to the brakes 22 via the outlet port 132. The pressurized air moving through the electrically actuated valve 84 is contained with the housing 136 until it discharged from the housing 136.

The invention is not limited to the details above but may be modified within the scope of the following claims.

What is claimed is:

1. An electronically controlled brake valve comprising:
a housing;
an inlet port within said housing;
an inlet chamber within said housing in fluid communication with said inlet port, said inlet chamber having an inlet seat;
an inlet valve within said inlet chamber and said inlet chamber surrounding said inlet valve, said inlet valve having a bore therethrough and an inlet valve seat circumscribing said bore, said inlet valve being movable in an axial direction between a closed position wherein said inlet valve seat contacts said inlet seat, and an open position wherein said inlet valve seat is spaced from said inlet seat, a spring biasing said inlet valve toward said closed position;
a control piston slidably retained in a modulation chamber, said control piston sealingly mated with a sidewall of said modulation chamber to divide said modulation chamber into a dispensing side and a control side, said control piston having a control piston seat for contacting said inlet valve seat, said control piston movable between an open position wherein said control piston seat is spaced from said inlet valve seat, a holding position wherein said control piston seat contacts said inlet valve seat while said inlet valve seat is in contact with said inlet seat, and a cracked position in which said control piston seat contacts said inlet valve seat and said inlet valve seat is spaced from said inlet seat thereby locating said inlet valve into its open position, said open position of said inlet valve providing fluid communication between said inlet chamber and said dispensing side and said closed position of said inlet valve sealing said inlet chamber from fluid communication with said dispensing side;
an outlet port within said housing, said outlet port in fluid communication with said dispensing side;
a modulation passage in fluid communication with said inlet chamber;
a first modulation valve for selectively connecting said modulation passage to said control side to facilitate a flow of fluid from said inlet chamber into said control side;
a second modulation valve for relieving pressure from said control side;
a controller for receiving a proportional braking signal, said controller processing said proportional braking signal and operating said first and second modulation valves to control fluid pressure on said control side and thereby moving said control piston to control fluid flow at said outlet port.

2. The electronically controlled brake valve of claim 1, being connectable to a towing vehicle providing said proportional braking signal.

3. The electronically controlled valve of claim 2, wherein said towing vehicle includes a constant power circuit for providing power to said controller.

4. The electronically controlled valve of claim 3, being connected to a constant power source independent of said towing vehicle.

5. An electronically controlled brake valve comprising:
a housing;
an inlet port within said housing for receiving pressurized fluid from a pressurized fluid source;
an inlet chamber within said housing in fluid communication with said inlet port, said inlet chamber having an inlet seat;
an inlet valve within said inlet chamber and said inlet chamber surrounding said inlet valve, said inlet valve having a bore therethrough and an inlet valve seat circumscribing said bore, said inlet valve being movable in an axial direction between a closed position wherein said inlet valve seat contacts said inlet seat, and an open position wherein said inlet valve seat is spaced from said inlet seat, a spring biasing said inlet valve toward said closed position;
a control piston slidably retained in a modulation chamber, said control piston sealingly mated with a sidewall of said modulation chamber to divide said modulation chamber into a dispensing side and a control side, said control piston having a control piston seat for contacting said inlet valve seat, said control piston movable between an open position wherein said control piston seat is spaced from said inlet valve seat, a holding position wherein said control piston seat contacts said inlet valve seat while said inlet valve seat is in contact with said inlet seat, and a cracked position in which said control piston seat contacts said inlet valve seat and said inlet valve seat is spaced from said inlet seat thereby locating said inlet valve into its open position, said open position of said inlet valve providing fluid communication between said inlet chamber and said dispensing side and said closed position of said inlet valve sealing said inlet chamber from fluid communication with said dispensing side;
an outlet port within said housing, said outlet port in fluid communication with said dispensing side;
a modulation passage in said housing in fluid communication with a pressurized fluid source;
a modulation valve for selectively connecting said modulation passage to said control side to facilitate a flow of pressurized fluid into said control side and for selectively releasing pressurized fluid from said control side;
a second modulation valve for relieving pressure from said control side;
a controller for receiving a proportional braking signal, said controller processing said proportional braking signal and operating said second modulation valve to control fluid pressure on said control side and thereby moving said control piston to control fluid flow at said outlet port.

6. The electronically controlled brake valve of claim 5, wherein said modulation valve is a first modulation valve for selectively allowing passage of pressurized fluid into said control side, and further comprising a second modulation valve operated by said controller for releasing pressurized fluid from said control side.

7. The electronically controlled brake valve of claim 5, being connectable to a towing vehicle providing said proportional braking signal.

8. The electronically controlled valve of claim 7, wherein said towing vehicle includes a constant power circuit for providing power to said controller.

9. The electronically controlled brake valve of claim 6, being connectable to a towing vehicle providing said proportional braking signal.

10. The electronically controlled valve of claim 9, wherein said towing vehicle includes a constant power circuit for providing power to said controller.

11. An electronically controlled brake valve comprising:
a housing;
an inlet port within said housing for receiving pressurized fluid from a pressurized fluid source;
an inlet chamber within said housing in fluid communication with said inlet port, said inlet chamber having an inlet seat;
an inlet valve within said inlet chamber and said inlet chamber surrounding said inlet valve, said inlet valve having a bore therethrough and an inlet valve seat circumscribing said bore, said inlet valve being movable in an axial direction between a closed position wherein said inlet valve seat contacts said inlet seat, and an open position wherein said inlet valve seat is spaced from said inlet seat, a spring biasing said inlet valve toward said closed position;
a control piston slidably retained in a modulation chamber, said control piston sealingly mated with a sidewall of said modulation chamber to divide said modulation chamber into a dispensing side and a control side, said control piston having a control piston seat for contacting said inlet valve seat, said control piston movable between an open position wherein said control piston seat is spaced from said inlet valve seat, a holding position wherein said control piston seat contacts said inlet valve seat while said inlet valve seat is in contact with said inlet seat, and a cracked position in which said control piston seat contacts said inlet valve seat and said inlet valve seat is spaced from said inlet seat thereby locating said inlet valve into its open position, said open position of said inlet valve providing fluid communication between said inlet chamber and said dispensing side and said closed position of said inlet valve sealing said inlet chamber from fluid communication with said dispensing side;
an outlet port within said housing, said outlet port in fluid communication with said dispensing side;
a modulation valve for selectively connecting a modulation passage to said control side to facilitate a flow of fluid into said control side and for selectively releasing pressurized fluid from said control side;
a controller for receiving a proportional braking signal, said controller processing said proportional braking signal and operating said modulation valve to control fluid pressure on said control side and thereby moving said control piston to control fluid flow at said outlet port.

12. The electronically controlled brake valve of claim 11 wherein said modulation valve is a first modulation valve for selectively allowing passage of pressurized fluid into said control side, and further comprising a second modulation valve operated by said controller for releasing pressurized fluid from said control side.

13. The electronically controlled brake valve of claim 12, being connectable to a towing vehicle providing said proportional braking signal.

14. The electronically controlled valve of claim 13, wherein said towing vehicle includes a constant power circuit for providing power to said controller.

15. The electronically controlled brake valve of claim 11, being connectable to a towing vehicle providing said proportional braking signal.

16. The electronically controlled valve of claim 15, wherein said towing vehicle includes a constant power circuit for providing power to said controller.
